(19) United States
(12) Patent Application Publication
(10) Pub. No.: US 2006/0253537 A1
(43) Pub. Date: Nov. 9, 2006

(54) METHOD AND SYSTEM FOR PROVIDING AUTOMATED EMAIL OPTIMIZATION

(76) Inventor: Ragy Thomas, Edison, NJ (US)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/381,202

(22) Filed: May 2, 2006

Related U.S. Application Data
(60) Provisional application No. 60/677,525, filed on May 4, 2005.

(51) Int. Cl. G06F 15/16

(52) U.S. Cl. 709/206

(57) ABSTRACT

A method and system for providing rules-based or algorithms based automated response optimization in the email-marketing environment such that recipient responses during the delivery process of an email campaign influence the delivery parameters and/or message elements of the portions of the campaign yet to be mailed. Responses to an email marketing campaign determine its marketing effectiveness and include delivery statistics, undeliverable statistics, opens, link-clicks, replies, opt-outs, and conversion events. Conversion events are recipient actions that are intended results from the marketing campaign and include marketing or service transactions that are completed online (e.g. purchases, registrations, filling out surveys, etc) and/or offline (e.g. brand awareness, store visits etc.). The system monitors emails as they are being received by recipients during delivery and, based on rules established by the marketer or on default rules established by the system using algorithms, tracks designated response statistics and dynamically alters the email elements, such as subject line and/or other content, including clickable links so that messages that produce the most desirable response statistics is sent to a greater percentage of the remaining recipients. Rather than completing the entire emailing operation using the same content throughout, this invention allows for changing the content for emails remaining to be sent so that the more effective content (in terms of stimulating favorable recipient reactions and purchases) is delivered to as many of the recipients as possible. Additionally, the process may be applied between separately mailed campaigns so that the delivery parameters for subsequent campaigns in a “campaign stream” are automatically modified based on the results of the prior campaigns in the stream and on the rules being applied to the stream.

### CROSS REFERENCE TO RELATED APPLICATION

This application claims priority to U.S. Provisional Patent Application Ser. No. 60/677,525, filed May 4, 2005, which is hereby incorporated herein by reference.

### BACKGROUND OF THE INVENTION

Email messaging is a powerful and cost-effective way to market products or services and build relationships with customers and prospects. It is no longer an “emerging” marketing channel but has instead become a required tool for any successful marketing plan. In fact, consumers expect (and many prefer) marketers to have an email communication channel. There are a number of reasons for the success of email marketing.

Email is a true push mechanism. Marketing emails are delivered right to the point of sale. The consumer can click on a link in your email and be taken to a page on which to purchase an item. Nothing can be faster.

Email is direct marketing with real time feedback. Reports are available as soon as a mailing is delivered and are updated every time a recipient opens an email or clicks on a link in an email.

Email can be highly personalized. Personal information about customers (name, age, gender, purchase preferences, etc.) can be used to target emails to those with specific interests/needs. There is nothing like a personal message to attract attention and motivate a response.

Email has high response rates. Response rates of 30-40% are not uncommon.

Email is easy to respond to and requires no stamps or envelops.

Email can incorporate rich multi-media experience. All the latest Internet technology is available for an email campaign, including Flash and streaming audio/video.

Email marketing can be accomplished at substantially lower costs than other means.

Email reaches a wider audience in a shorter time period for far less money than needed to invest in a comparable direct marketing campaign.

Email marketing is not “one-off” spot communication but rather a sustained, evolving dialogue that builds and maintains customer relationships.

A marketing email consists of the list of email addresses to which the mailing is to be sent and the content to be sent to those addresses. Content itself can contain text, pictures, multi-media data, HTML, scripts, and the like as well as links that can be clicked on by the email recipient and that lead to Internet URLs that themselves contain information and/or items for sale.

As a mailing goes out, statistics can be automatically accumulated about the number of messages sent and what happens to them. These statistics are available in the form of reports generated by the computer based mailing application. Reports contain information not only on how many emails were sent but on what happened to them (“responses” generated), i.e. how many were actually received, how many failed to be delivered, how many were opened and read by recipients, how may optout requests were made (requests to be removed from a mailing list), how many times links within the email were clicked on so that the recipient could view a website, how many email replies were generated, and generally how “successful” the email was. A “successful” email is gauged by what the marketer hopes to achieve and is often measured by tracking recipient reactions or events that the email campaign directly or indirectly generated. Different marketers may have different objectives, and therefore each marketer will determine “success” by the occurrences of a different type of result or event prompted by the email. For example, for one marketer, mere delivery of the email to a targeted recipient (or an indication that the email is undeliverable to a targeted recipient) is success. For another, having the recipient open the email (thus enhancing the chances that the recipient has read the content) is success. To another marketer, success is when a recipient clicks on a particular link embedded in the email. For others, success is only achieved when a recipient makes a purchase of goods or services either as a result of the email content or because the recipient clicks on a link to a website and makes an online purchase from the website. Numerous other events can be tracked and used to gauge a successful email, such as, but not limited to time spent at a clicked through website, signing on to a clicked through website, numbers of purchases made, and other similar events. The foregoing types of events are typically referred to collectively as “response events” or just “responses.” A response event of a particular type may be referred to herein as a “selected response event.” Examples of various types of selected response events are described hereinbelow. A “conversion” or “conversion event” is a type of response event generally encompassing any specific action by a recipient that was the intended objective of the marketer, such as an online purchase of goods or services made by the email recipient as a result of the email. Other conversion events include other types of transactions that are completed online, such as, online registrations, filling out surveys, etc., and/or offline activities, such as creating brand awareness, store visits, etc. The use herein of the expression “conversion” or “conversion event” is intended to include all such responses. Marketers seek to generate as many selected response events as possible. When higher volumes or rates of selected response events are achieved using particular content of an email, or using particular links in the email, as opposed to other content which generates lower volumes of selected response events, the marketer will naturally modify future emails to replicate the high rates or volumes of selected response events.

It is thus through the analysis of the mailing statistics that marketing decisions are made. Marketers are looking for results showing them the effectiveness or non-effectiveness of email content by measuring selected response events, such as opens, click-through, sales, conversions, and the like. As with print or other non-computer driven advertising, different versions of marketing messages can generate better or worse results and better or worse selected response event rates. Thus, different versions of the email can be sent and then their resulting response events measured for each email for effectiveness. With current technologies, these results are available only after the mail has been completely delivered and the recipients have reacted, as indicated by a conversion event or by some other response event. Once results are measured, the next round of email can contain content that produced the higher volume or rate of selected response events and hopefully result in better future selected response events, such as, opens, click-throughs, sales, conversions, etc.

The problem with the approach of waiting to measure the results is that there can be a significant lag time between sending the emails, measuring results (i.e., conversion events or another type of response event), changing content, and resending. To take fullest advantage of the email medium, it would benefit marketers if they could measure conversion and other response events and make changes to content as the mailing is being sent. The present invention achieves this objective and overcomes the prior difficulties.

### SUMMARY OF THE INVENTION

The system and method of the present invention will allow for automatically altering content and other messaging elements during the email delivery process so that mailing list members to which an email is yet to be delivered are able to be sent different content than that received by list members to whom the email has already been delivered.

The invention is implemented by taking advantage of a number of elements of email delivery systems:

Content can be dynamically combined with recipient email addresses. This means that content can be altered depending on demographic or other marketing characteristics of individual email recipients.

Recipient conversions, or other response events, such as opens or link clicks are measured in real-time (as they happen). A mailing to, for example, 8,000,000 subscribers (not uncommon) may take some hours to complete while selected response events from individual recipients can be detected minutes after the mailing has started being sent.

Any time during an electronic mailing, it is known who has been sent email and who remains to be sent email. Thus, the mailing process can be automatically monitored and controlled.

Campaigns to a large number or recipients can be automatically broken down into smaller portions by the system. These portions can be as small as an individual recipient or much larger (e.g. portions of 100,000 recipients). Alternatively, campaign streams can be set up such that the mailings in each campaign are sent automatically at different points in time.

The invention provides a system that tracks selected recipient response events as they occur during email delivery and feeds those results back into the system so that various message or content elements (sending Internet Protocol (“IP”) address, subject line, text, graphics, clickable hyperlinks, placement of links, etc.) that are producing the most favorable responses, or the greatest amounts of selected response events, can be automatically incorporated into the emails to be sent to targeted recipient addresses to which emails have yet to be sent. To achieve this, message or content elements can be changed on the fly (e.g. switch IP address automatically) or another version of the message with different message or content elements (that was pre-created and stored in the system) can be substituted in place of the message that was just sent out. This is accomplished by constantly comparing observed conversion or other response statistics for messages with different message or content elements against a database of rules that indicates at what threshold changes or version substitutions need to be made. Alternatively the system can use software algorithms to alter message or content elements dynamically, measure conversion or other response statistics and make decisions on changing message or content elements or switch versions.

For example, if a mailing is sent to 8,000,000 recipients who each have a choice of clicking on Link A or Link B in the delivered email and in fact 30% of the first 1,000,000 recipients click on Link A, while 10% of this same group click on Link B, and 60% of this same group click on neither, then we know that Link A gathered the most of a selected response event. The system then has a number of choices that can be made in real time (as the email is continuing to be sent to remaining recipients) rather than after all 8,000,000 emails have gone out:

Depending on pre-established rules, the system can replace Link B with another link, such as Link C and examine how this choice fares against Link A as the emails continue to be sent.

Alternatively, the system can alter the subject line of the email, the text or other copy that accompanies Link B to see whether these changes alter the outcome.

In addition, the system can eliminate Link B altogether to see whether its absence increases the number of recipients who select Link A.

As the mailing continues, the system continues to monitor the results and measure selected response events and to make additional changes to test other options which may have been provided for. Not only does this approach allow for testing to take place and modifications to be made during the mailing, but it also provides for the marketing message producing the most favorable responses to be mailed to many more recipients than would be possible if we had to wait for the entire 8,000,000 emails to be sent before knowing how effective different approaches had been.

While the invention allows for optimizing any selected response event, some specific examples are described below for illustrative purposes.

Automatically optimizing the selected response event of “deliverability rate”: Internet Service Providers (“ISP's”) and corporate networks that receive email on behalf of subscribers employ several tactics to identify whether incoming email is spam. These tactics include but are not limited to: (i) checking the sending IP (i.e., identifier of the sender) against a list of IP addresses that are known to send spam; (ii) checking or scoring the content against predefined content rules to measure the likelihood that the content is similar to that found in typical spam messages; and (iii) providing subscribers with the ability to electronically “report spam” using feedback mechanisms on email client user interfaces and by measuring the number of times subscribers “report spam” against specific email messages.

The invention provides for a method of automatically optimizing deliverability rates of an email marketing campaign using a rules-based or algorithm-based computer system in which a list of email addresses of targeted recipients for receiving a marketing message is stored. The list can be divided into a plurality of portions. A marketing message, including the content for an email to be sent to targeted recipients, is then created. Email messages are then sent to targeted recipients in the first portion of the list and the deliverability to each ISP is then observed prior to emails being sent to targeted recipients in other portions of the list. The sending IP or the content is then dynamically modified using predetermined alterations based upon measured deliverability statistics, prior to sending emails to targeted recipients in other portions of the list, in an effort to improve deliverability.

Automatically optimizing the selected response event of “open rate”: Subscribers open email messages typically based on: (i) who the message is from, as identified by the visible “from address”; (ii) the feedback provided by the Internet Service Provider or the corporate email server on the authenticity or reputation of the sender as identified by the sending IP address; (iii) the subject line of the message; and (iv) content of the message as it appears in the preview or content pane of the email client's user interface.

The invention thus further provides a method of optimizing an email marketing campaign's open rate by using a rules-based or algorithm-based computer system in which a list of email addresses of targeted recipients for receiving a marketing message is stored. The list can be divided into a plurality of portions. A marketing message, including the content for an email to be sent to targeted recipients, is then created. Emails are then sent to targeted recipients in the first portion of the list and the open rate is observed prior to emails being sent to targeted recipients in other portions of the list. The sending IP address, the “from address”, the subject or the content is then dynamically modified, using predetermined alterations based upon the measured open rate statistics, prior to sending emails to targeted recipients in other portions of the list, in an effort to improve open rate.

Automatically optimizing the selected response event of “click through rate”: Once a message has been opened, typically the next logical step in the response event sequence is for subscribers to click on a hyperlink that would take them to web pages where additional information can be obtained or a transaction can be consummated. The message content within the email is what drives a subscriber to click on a hyperlink. Hyperlink clicks within email campaigns are tracked for reporting purposes. The system accomplishes click through tracking by replacing each hyperlink inside of the email with a tracking link before email is delivered. Tracking links are URLs with encoded parameters that identify the subscriber, the email message and original hyperlink from the email message. When a subscriber clicks on a tracking link, the system records the click-through action for reporting purposes and redirects the subscriber to the original hyperlink.

The invention therefore also provides a method of optimizing an email marketing campaign's click through rate by using a rules-based or algorithm-based computer system in which a list of email addresses of targeted recipients for receiving a marketing message is stored. The list can be divided into a plurality of portions. A marketing message, including the content for an email to be sent to targeted recipients, is then created. Emails are then sent to targeted recipients in the first portion of the list and the click through rate is observed prior to emails being sent to targeted recipients in other portions of the list. The offer or any other element within the body or the subject line is then dynamically modified, using predetermined alterations based upon the measured click through statistics, prior to sending the email to targeted recipients in other portions of the list, in an effort to improve click through rate.

In some cases the call to action is subsumed within the email body content and does not need URL click throughs. An example would be purchases from an email with an embedded purchase form. Other examples are cases when the desired action is not web based but are offline events such as phone calls, or store visits. This is also the case when the desired action is increasing brand awareness or information dissemination. The technique mentioned above can be applied to increase the conversion rate in these cases as well.

Automatically optimizing the selected response event of “conversion rate”: Typically email campaigns provide information in the body of the email and encourage subscribers to click through on embedded hyperlinks to complete transactions on destination web sites. These destination web sites are sometimes referred to as landing pages. Various transactions can be conducted via these landing web sites (e.g. online purchases, registrations etc.). It is possible to track these conversion events on these web pages and attribute them back to the email campaign by either dropping a cookie on the subscriber's computer when a link is clicked within the email or by passing a tracking code within each link.

The invention therefore also provides for a method of optimizing an email marketing campaign's conversion rate by using a rules-based or algorithm-based computer system in which a list of email addresses of targeted recipients for receiving a marketing message is stored. The list can be divided into a plurality of portions. A marketing message, forming the content for an email to be sent to the targeted recipients, is then created. Emails are then sent to targeted recipients in the first portion of the list and the conversion rate is then observed prior to emails being sent to targeted recipients in other portions of the list. The conversion rate is observed by tracking conversion activities online (e.g. tracking online purchases triggered by the email campaign) or offline (e.g. tracking phone or in store purchases triggered by the email campaign). The email content including the embedded URL to click through is then dynamically modified, using predetermined alterations based upon the measured conversion rate statistics, prior to sending emails to targeted recipients in other portions of the list, in an effort to improve conversion rate.

In the case of optimizing conversions, the invention also provides for a method of optimizing an email marketing campaign's conversion rate after the campaign has been completely sent out. This is accomplished by measuring conversions on landing pages and dynamically changing the landing page URL to a different one in an effort to improve conversion rate.

Automatically optimizing the selected response event of “reply rate”: Some or all of the techniques applicable to optimizing deliverability, open rate, click through rate and conversion rate can also be utilized for automatically optimizing reply rates. It should be noted that sometimes optimizing email replies equates to eliciting more replies, as in the case of purchase orders via email replies, whereas in other cases optimizing replies equates to dissuading subscribers from replying as in the case of customer service inquiries or complaints.

Automatically optimizing the selected response event of “unsubscribe rate”: Some or all of the techniques applicable to optimizing deliverability, open rate, click through rate and conversion rate can also be utilized for automatically optimizing unsubscribe rates. Typically, optimizing unsubscribe rates means dissuading subscribers from opting out from further email communications via an email unsubscribe request or an opt-out web page

### BRIEF DESCRIPTION OF THE DRAWINGS

A more complete description of the invention and the attendant advantages thereof will become better understood when referring to the accompanying drawings wherein:

FIG. 1 shows a sample portion of an email list (mailing list) that includes email addresses;

FIG. 2 illustrates sample information maintained by the email system for mailing list members. This information, termed ‘attributes’, consists of data collected by a business or organization about its ‘subscribers’, i.e., those who receive emails from the business or organization;

FIG. 3 is a sample table of subscriber attributes based on gender (M, W) and a credit rating (1,2,3). These attributes represent data collected by a business or organization about its email recipients;

FIG. 4 illustrates sample email content in which the fixed content is sent to all recipients while the variable content may change from subscriber to subscriber depending on each subscriber's attributes;

FIG. 5 is a block diagram illustrating the underlying structure of a mailing in which variable email content is matched with segments (portions of a mailing list that contain certain common attributes) to build the delivered email;

FIG. 6 illustrates the three standard formats of email content: Text, AOL, HTML;

FIG. 7 schematically shows a process whereby email content is matched against subscriber attributes to produce the delivered mailing;

FIG. 8 illustrates a mailing structure in which men and women will be sent different content while those with different credit ratings will get either the Credt1A content or the Credit2A content;

FIG. 9 illustrates Credit1B and Credit2B offers being sent to recipients with credit rating 1 or credit rating 2;

FIG. 10 is a summary of the automated email optimization mailing;

FIG. 11 shows a screen that contains the eMarketing dash board used to modify hyperlinks within email content after the content has been received;

FIG. 12 is an illustration of how a tracking hyperlink is used to mask an actual hyperlink within an email for click through reporting purposes;

FIG. 13 is a flow chart illustrating the flow of information followed for conversion tracking also known as Post Email Event tracking (PEET);

FIG. 14 is a flow chart further illustrating aspects of the method of the invention; and

FIG. 15 is a schematic representation illustrating aspects of the system of the invention.

### DETAILED DESCRIPTION

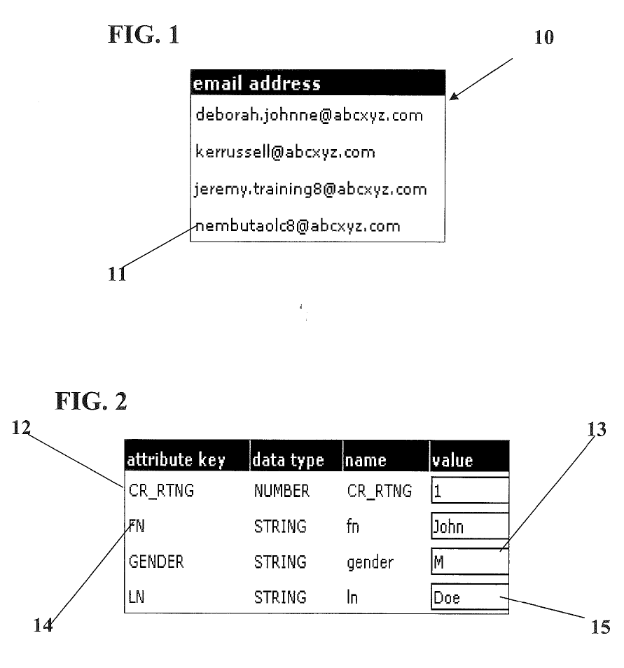

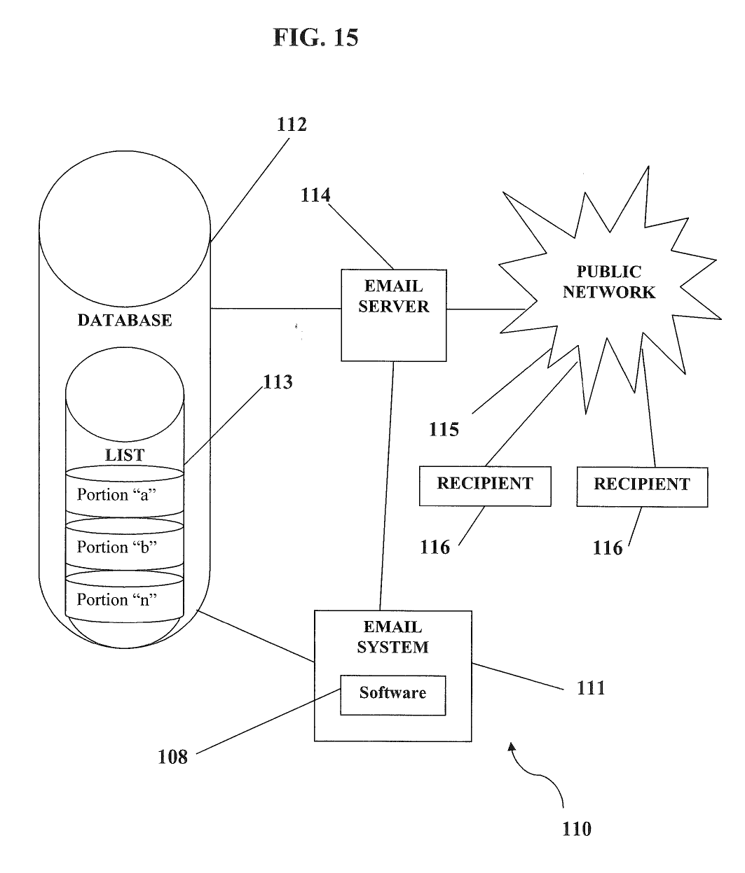

A computer based email delivery system must have access to a list 10 of email addresses such as that shown in FIG. 1, which may be stored in a database 112 (see FIG. 15), to which email can be sent. Each email address identifies a specific email list member 11, with these list members also being called subscribers or recipients. As illustrated in FIG. 15, the list may be segmented into portions “a”; “b”; . . . “n”. While the information shown in this FIG. 1 is sufficient to send a marketing message to each recipient, there is no information in the list that allows the marketer to send different messages to different list members based on any quality or preference criteria of the list members.

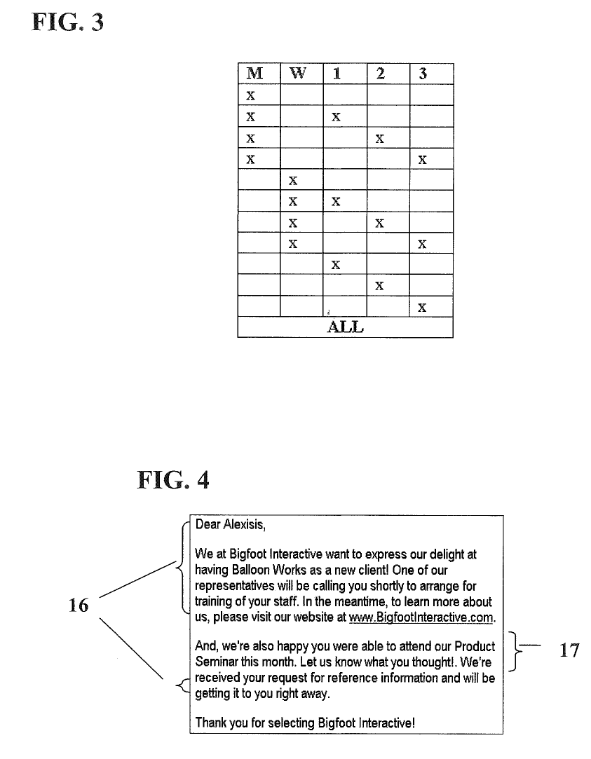

FIG. 2 illustrates sample information electronically maintained by the email system for mailing an email containing a marketing message to list members. The information in the sample consists of attributes or characteristics, such as, a credit rating 12 (CR_RTNG), GENDER 13, and first and last names 14 and 15 respectively (FN, LN). Even this limited amount of information allows the marketer to develop different marketing messages for recipients with different credit ratings and/or of different gender. It is possible, for example, to send one offer to a woman with a credit rating of “2” and a different offer to a man with the same rating. It is also possible to send one offer to men only and another to women only without regard for credit rating values. It is, in fact, possible to send twelve different combinations of marketing messages to this mailing list as shown in FIG. 3.

One way to deal with this type of marketing requirement would be to construct content for twelve different emails and send the appropriate content to each recipient. This is, however, tedious and time-consuming. It would be much better to construct the marketing copy in discrete units and then combine those units for each recipient based on that recipient's attributes. FIG. 4 illustrates sample email content in which fixed content element 16 is sent by an email server, shown schematically in FIG. 15 and well known to those skilled in the art, to all recipients while the variable content element 17 changes depending on each recipient's attributes.

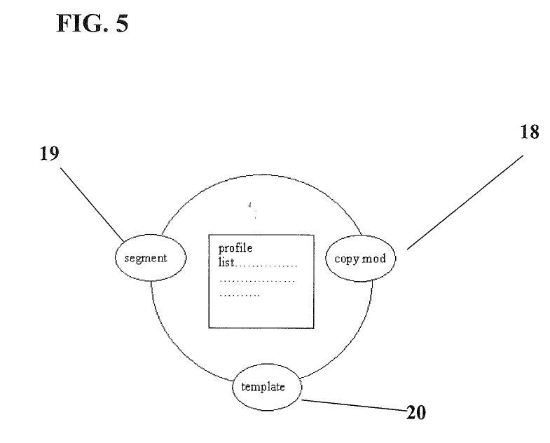

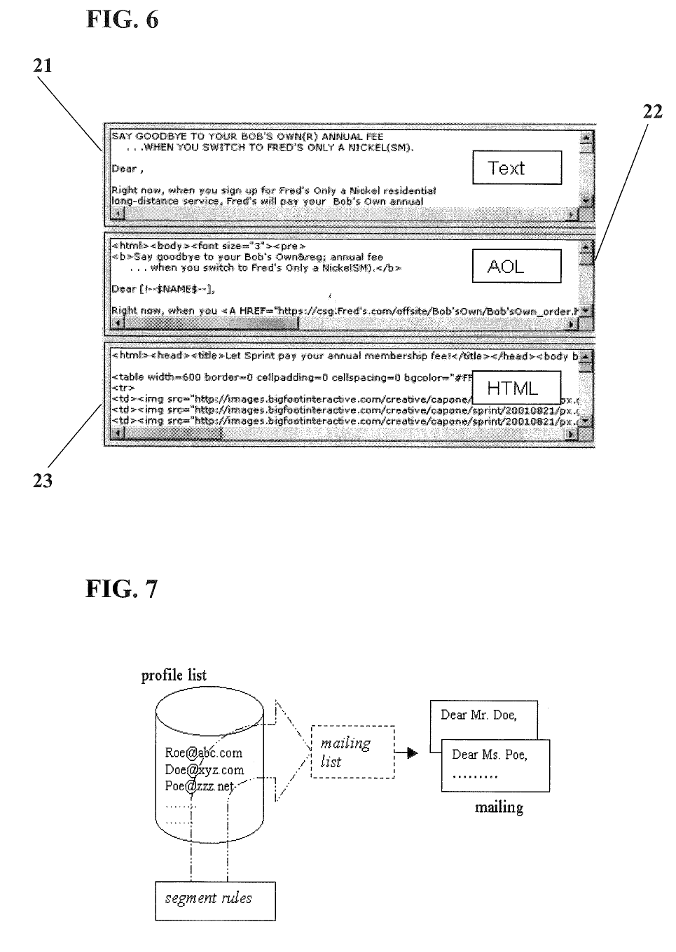

The degree to which content may vary inside an email is unrestricted. FIG. 5 illustrates the underlying structure of a mailing in which variable email content 18 (copy mods) is matched with criteria 19 (segments) specifying portions of a mailing list that contain certain common attributes to build the delivered email 20 (templates). This approach allows for constructing emails by associating content portions with criteria that test each recipient's attributes and include in the delivered email for each recipient only those portions appropriate to the recipient's attribute values. This method of constructing an email can be applied to all of the formats of email content (Text-21, AOL-22, HTML-23) as shown in FIG. 6.

FIG. 7 illustrates the process whereby email content is matched against subscriber attributes to produce a mailing. Using the invention, this process is fully automated so that behavioral actions by a first portion of recipients that are contained in the database will be tested for selected conversion events and, as the mailing process continues, will be used to modify the content still to be sent.

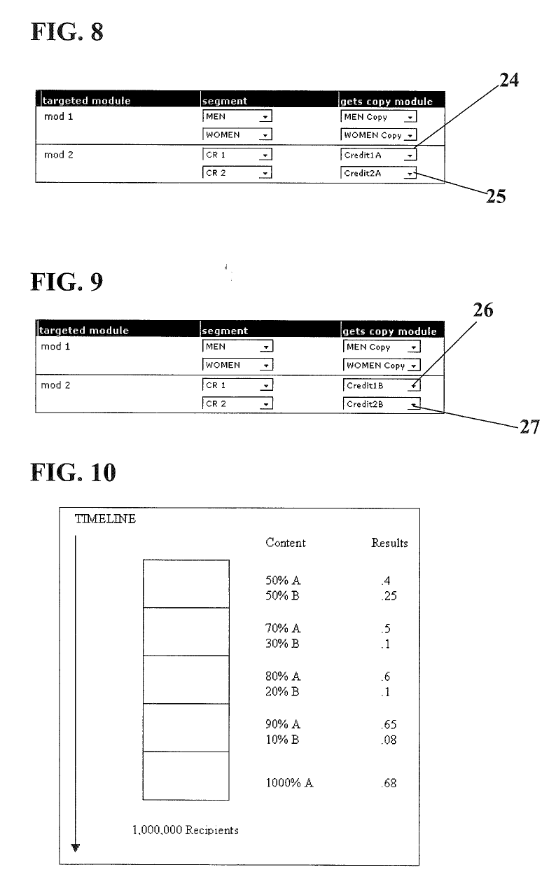

FIG. 8 illustrates a structure in which men and women will be sent different content while those with different credit ratings will get either the Credt1A 24 content or the Credit2A 25 content. FIG. 9 illustrates Credit1B 26 and Credit2B 27 offers being sent to recipients with credit rating “1” or credit rating “2”. In both cases tests are made against the attributes of the email recipient at the time of mailing and the appropriate offer is added to the email depending on the results. It is at the time of mailing that the attributes of each email recipient are tested against the prevailing criteria and the mail sent is constructed from tables such as the one shown in the Figure.

FIG. 10 illustrates an automated email optimization mailing in which different percentages of “A” and “B” copy are sent to portions of the list not yet mailed to depending on the results of previously sent emails. In the illustration, there are 1,000,000 emails to be sent and the results of testing are used to modify the content being sent after each 200,000 email sends. The first mailing is sent to each portion of the mailing list with the result that 40% of the recipients reacted favorably to Copy A while only 25% reacted favorably to Copy B.

When the second 100,000 mailings are sent, the system of the invention has reset the send percentages based on the initial results so that 70% of the recipients will now receive Copy A and 30% will receive Copy B. The results this time are even more favorable for Copy A with 50% of recipients reacting to it.

When the third group of 200,000 mailings are sent the system has again modified the send percentages so that 80% of the recipients will get Copy “A” while only 20% receive Copy “B”. This time 60% of recipients respond to Copy “A”. As more and more recipients receive Copy “A”, more and more of them are responding to it.

In the fourth test, 90% of the recipients receive Copy A and again the reaction to this copy increases. In the last mailing, 100% of the recipients receive Copy A. As can be seen from the illustration, the total reaction rate on this mailing was 68% while the total reaction rate on the first mailing was 65% (40% A and 25% B). Not only did we find that Copy A was better than Copy B, we improved the overall reaction rate to the mailing as a whole.

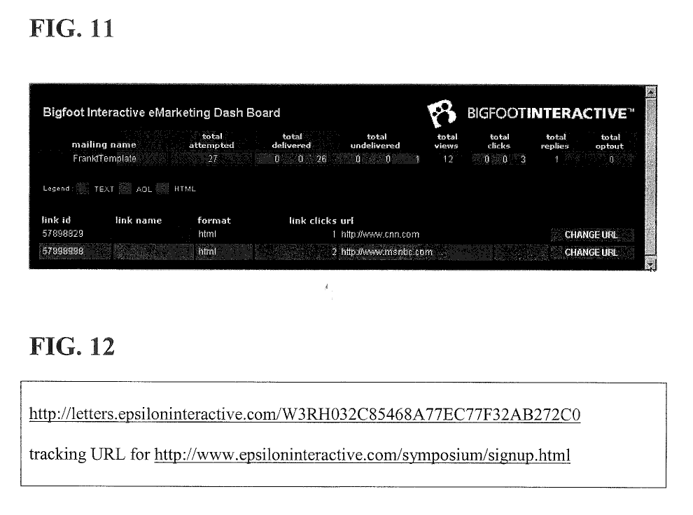

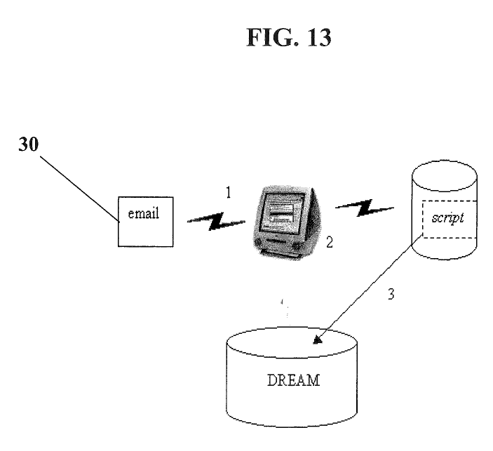

FIG. 11 illustrates the eMarketing dash board used to track responses as they occur and to allow for changes to be made to links within an email even after the campaign has finished mailing and all email has been delivered. This capability is used effectively with conversion events as well in which recipient actions outside of the email are monitored. As shown in FIG. 13, email 30 is opened by a recipient (step 1) who clicks on a conversion tracking-enabled link (step 2). When the selected web page is rendered, tracking code is passed to the computer based emailing system, designated as “DREAM” (step 3). The tracking code allows the computer based system to gather statistics on the email recipient's activities on web pages reached from links in the email.

This capability allows the marketer to design different web pages and automatically electronically track activity (or selected response events) on them after they are reached from a hyperlink in an email. If it turns out that one of the pages is performing better than the other(s), the hyperlink to the web pages in emails, whether undelivered or delivered, can be changed to point to the better performing web page.

While the above discussion illustrates one specific optimization technique, the same concept can be applied to optimize any and all email response and conversion events. In all of these applications, the invention uses the dynamic nature of electronic communications and computer based programs to automatically modify content and or other message elements during a campaign and/or between campaigns in order to achieve the best possible marketing results.

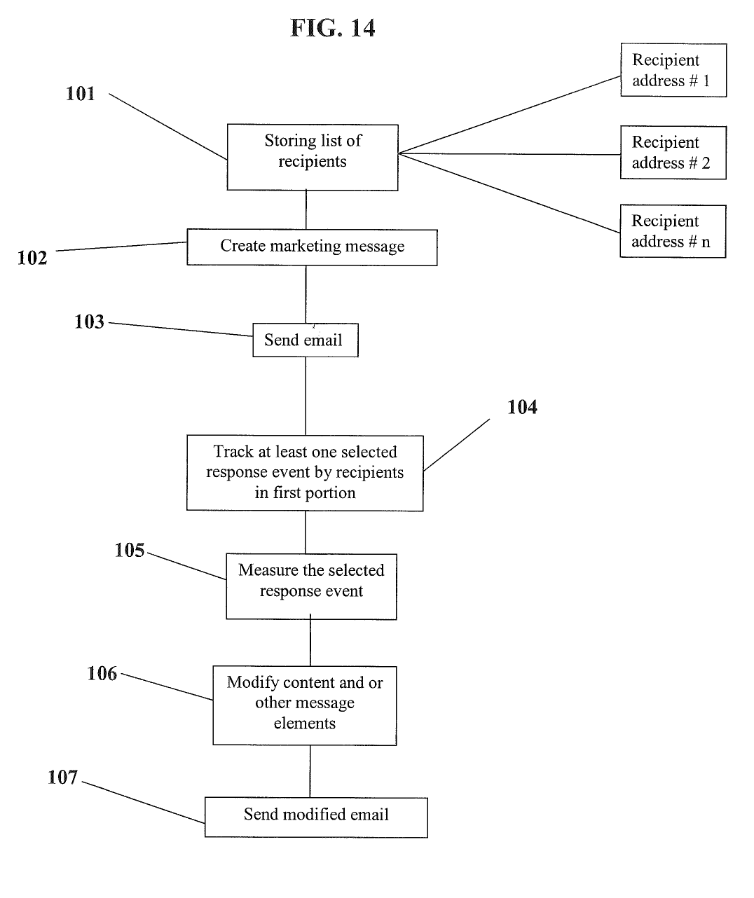

The method of the present invention is further illustrated in the flow chart of FIG. 14. As shown, a first step in optimizing the email marketing campaign of the present invention is the electronic storing of a list of email addresses of targeted recipients, step 101. As described above (see FIG. 2), each recipient's address in the list contains coded information regarding certain attributes or characteristics of that targeted recipient. The coded information is stored electronically with the list. Step 102 is the creation of content for the marketing message to be sent to the targeted recipients. The coded characteristics of the recipients in a first portion of the list are used to create an initial optimized message, as is discussed above. Thus, the message contains information based upon the various characteristics or attributes of the recipients in the first portion of the list. The message, as noted above, contains both fixed and variable content elements (see FIG. 4). The completed marketing message is then sent via email, at step 103, over a public network, such as the Internet, to the targeted recipients in the electronic list. The email may be sent to recipients in only one or more portions of the list. As the sent email is received by the recipients in the first portion of the list, each recipient will either react to the email by taking certain actions, or by doing nothing. Such action can include one or more conversion event or other type of response event, such as, open the email, click on a link in the email and open a designated website, register at the website, make a purchase at the website, provide information as requested by the email, or any number of other possible actions. A marketer, or sender of the email, may wish to track a selected one or more of such response events. Indeed, the sender will also want to track whether the email was correctly delivered to the targeted recipient or if it is undeliverable to that recipient. These actions/events will be electronically tracked by the system at step 104. As the responses events are being received and tracked by the email server, the system of the invention, which includes computer based software coupled to the email server (see FIG. 15), measures, at step 105, the selected response events in order to determine attributes or preferences of the recipients in the first portion of the list. At step 106, the system of the invention, using rules based or algorithm based software, modifies the content of the sent marketing message in accordance with the measured selected response event. Modification of the content will automatically occur when the rules based software detects selected conversion events reaching a prescribed threshold or comparing conversion events among selected recipients. At step 107, the email server sends the modified marketing message in an email to recipients in other portions of the list.

The system 110 of the invention is schematically illustrated at FIG. 15. The system 110 is a computer based system including computer capabilities 111 with appropriate software 108. The computer based software is coupled to, or otherwise has access to, an electronic database 112 which contains the list 113 of targeted recipients. The list is divided into various portions a, b, . . . n. As noted above, the addresses of targeted recipients contain attributes or characteristics of each targeted recipient (see FIG. 2). Once the content of the marketing message is created using the information from the list 113 and traditional input means well known in the art, the computer based software, coupled to the email server 114, instructs the email server to send the message in an email over a network, such as a public network like the Internet, 115. Recipients 116 receive the marketing message via the network 115. The conversion or other response events generated by the recipients 116 are accessible to, or otherwise transmitted over the network 115 back to the email server 114. The software 108 is capable of measuring the selected response events and automatically modifying the content of the marketing message based upon the characteristics, attributes and/or preferences as determined by the measured selected response events. Based upon the measured selected response events, the software/computer based system automatically generates a modified message which is then transmitted to the email server and sent via the network to targeted recipients in other portions of the list.

Although the present invention has been described in detail with reference to certain preferred embodiments, it should be apparent that modifications and adaptations to those embodiments may occur to persons skilled in the art without departing from the spirit and scope of the present invention. Therefore, the breadth of the present invention should not be limited by the particular illustrative examples but rather by the following claims.

What is claimed is:

1. A method of optimizing response of an email marketing campaign comprising:
creating a marketing message in the form of an email;
sending said email to a predetermined number of targeted recipients;
electronically tracking at least one selected response event occurring as said email is being sent to said targeted recipients; and
automatically modifying said email by changing elements thereof in accordance with said tracked selected response event.

2. The method according to claim 1 further comprising measuring the volume of said tracked selected response event, and wherein modifying said email is determined by said measurement.

3. The method according to claim 1 further comprising sending said email to a first portion of said predetermined number of targeted recipients prior to modifying said email.

4. The method according to claim 3 further comprising sending said modified email to other portions of said predetermined number of targeted recipients.

5. The method according to claim 1 further comprising electronically accessing said targeted recipients from a database containing a list of said recipients.

6. The method of claim 1 wherein said modifying is activated by a rules or algorithm based software.

7. The method of claim 1 wherein said selected response event is selected from the group consisting of: deliverability rate; open rate; click through rate; conversion rate; purchase rate; reply rate; and unsubscribe rate.

8. The method of claim 1 wherein said selected response event is conversion rate, and wherein said email is sent to said entire predetermined number of targeted recipients.

9. A method of optimizing an email marketing campaign comprising:
creating a marketing message including content for an email to be sent to a predetermined list of recipients, said list being divided into a plurality of portions, said message containing information dependent upon known attributes of recipients in a first portion of said list, said content further containing fixed elements and at least one variable element, said variable element being subject to change;
sending said email containing said content to recipients in said first portion of said list;
automatically tracking at least one selected response event in response to said sent email; and
automatically modifying said content by changing selected content elements prior to sending said email to recipients in other portions of said list.

10. The method according to claim 9 further comprising a plurality of variable elements, and wherein modifying said content comprises changing more than one of said plurality of variable elements.

11. The method according to claim 9 wherein said list of recipients is electronically accessed from a database.

12. The method according to claim 9 wherein said attributes are electronically coded.

13. The method according to claim 9 wherein said variable element of said email is automatically determined by electronic means in accordance with the attributes of designated recipients.

14. The method according to claim 9 further comprising electronically tracking and measuring said at least one selected response event substantially contemporaneously with its occurrence.

15. The method according to claim 9 wherein said content contains electronic hyperlinks that can be clicked on for creating access to a designated web page.

16. The method according to claim 15 further comprising electronically tracking click through rates.

17. The method according to claim 9 further comprising sending said modified email to recipients in other portions of said list.

18. A method of optimizing an email marketing campaign comprising:
electronically storing a list of email addresses of targeted recipients for a marketing message, said list being divided into a plurality of portions;
creating said marketing message as content for an email to be sent to said targeted recipients, said message containing information dependant upon known characteristics of recipients in a first portion of said list,
sending said email containing said content to targeted recipients in a first portion of said list;
tracking selected response events in response to said sent email to said targeted recipients in said first portion of said list;
automatically electronically measuring said tracked selected response events prior to said email being sent to targeted recipients in other portions of said list; and
automatically modifying said content based upon said tracked and measured selected response events by changing said content or message elements of said email prior to sending said email to targeted recipients in other portions of said list.

19. The method of claim 18 wherein said selected response event is selected from the group consisting of: deliverability rate; open rate; click through rate; conversion rate; purchase rate; reply rate; and unsubscribe rate.

20. A system for optimizing selected responses of an email marketing campaign comprising:
electronic means for creating a marketing message in the form of an email;
server means in communication with said electronic means for sending said email to a predetermined number of targeted recipients;
means for electronically tracking at least one selected response event occurring as said email is being sent to said targeted recipients; and
computer based means for automatically modifying said email by changing elements thereof in accordance with said tracked selected response event.

21. The system according to claim 20 wherein said server means is an email server.

22. The system according to claim 20 wherein said computer based means for automatically modifying said email includes rules based or algorithm based software.

23. A system for optimizing an email marketing campaign comprising:
a database for electronically storing a list of email addresses of targeted recipients of an email containing a marketing message;
an email server coupled to said database for sending said email to a first group of targeted recipients and for receiving electronic signals representative of at least one selected response event by said targeted recipients in said first group; and
computer based software coupled to said email server for electronically measuring said at least one selected response event as they occur; said computer based software including means for automatically modifying said email in accordance with said measured selected response event.

24. The system according to claim 23 wherein said computer based software contains rules or algorithms for modifying said email based upon desired measured selected response event.

25. A system for optimizing an email marketing campaign comprising:
a list of email addresses of targeted recipients for a marketing message;
means for electronically storing said list and for maintaining electronically coded characteristics for each of said targeted recipients, said coded characteristics being associated with each respective targeted recipient, said list being divided into a plurality of portions, said message containing information dependant upon said characteristics of recipients in a first portion of said list;
an email server coupled to said electronic storing means for sending said email containing said content to targeted recipients in said first portion of said list and for tracking at least one selected response event to said sent email by said targeted recipients in said first portion; and
computer based software coupled to said email server for electronically measuring said tracked at least one selected response event as said responses occur; said computer based software including means for modifying said content or any other message element prior to sending said email to targeted recipients in other portions of said list.

26. The system according to claim 25 wherein said computer based software contains rules or algorithms for modifying said email content or message element.

27. The system according to claim 25 wherein said content contains fixed content elements and at least one variable content element.

28. The system according to claim 27 further comprising a plurality of variable content or message elements, and wherein said computer based software modifies said content/message by changing more than one of said plurality of variable content/message elements.

29. The system according to claim 25 wherein said means for storing said list of recipients is an electronic database.

30. The system according to claim 27 wherein said at least one variable content/message element of said email marketing message is automatically determined by said software in accordance with said measured response event.

31. The system according to claim 25 wherein said content contains electronic links that can be clicked on for creating access to a designated URL.

32. The system according to claim 31 wherein said computer based software electronically tracks recipients' clicking on said links contained in said email.

33. The system according to claim 25 wherein said server sends said modified email to targeted recipients in other portions of said list.
